(19) United States
(12) Patent Application Publication
(10) Pub. No.: US 2002/0026301 A1
(43) Pub. Date: Feb. 28, 2002

(54) Automatic evaluation method, automatic evaluation system, and storage medium storing automatic evaluation program

(76) Inventor: Kazuyoshi Takeda, Chino-shi (JP)

Correspondence Address: HARNESS, DICKEY & PIERCE, PLC, P.O. BOX 828, BLOOMFIELD HILLS, MI, 48303, US

(21) Appl. No.: 09/881,564

(22) Filed: Jun. 14, 2001

(30) Foreign Application Priority Data
Jun. 14, 2000 (JP) 2000-178342

(51) Int. Cl. G06F 9/455

(52) U.S. Cl. 703/17

(57) ABSTRACT

Evaluation accuracy is improved by setting, for each input event, the number of states of an output screen which the input event can take (types of the output screen on which the input event is reflected and which is renewed) as number-of-repetitions data, and repeating an evaluation for the one input event by the number of times.

An automatic evaluation system automatically evaluates a program operating on a target system by referring to an output screen as a result of a simulation corresponding to an arbitrary input event, in which a simulator 31 performs the simulation, an output screen reference portion 112 refers to the output screen by the number of times corresponding to the number of states of the output screen on which the input event is reflected and which is renewed, and an evaluation system core 111 successively compares the reference result with reference data corresponding to the number of times which is prepared in advance so that an automatic evaluation is carried.

### TECHNICAL FIELD

The present invention relates to an automatic evaluation method, an automatic evaluation system, and a storage medium storing an automatic evaluation program, which can automatically evaluate a program operating on a target system from an input event such as a key input and a reference output resulting from this input event on, for example, an output screen.

### BACKGROUND ART

In recent years, microcomputers have been installed and widely used in various devices such as electrical domestic appliances. For the purpose of operating the microcomputer in accordance with the specification of the device in which it is installed, such as a peripheral device or the like, an application program is written in a built-in ROM (Read Only Memory). Liquid crystal display devices (hereinafter referred to as an LCD: Liquid Crystal Display) are also installed in various devices such as electrical domestic appliances. Thus, when an input event such as a key input by a user is inputted, the microcomputer causes an output screen corresponding to this input event to be outputted on the LCD by the application program. Then, in the case where the operation by the application program of the microcomputer is recognized, the microcomputer must recognize output results from a number of input events corresponding to the specification of the installation device.

Thus, in the development of the microcomputer, the development of the application program, together with the development of the hardware, is also important. In the development of the application program, an in-circuit emulator (hereinafter referred to as an ICE: In Circuit Emulator) or the like is used. The ICE can emulate the operation of the application program on a target board. As described above, in the operation confirmation of the application program, there are a number of input events to be confirmed. Thus, in the case where the operator directly inputs the input events by using the ICE, it takes a long time to input, and there is also a possibility that the operator makes an input mistake.

Besides this, in the case where the operator confirms the input event and the emulation result through the screen output or the like, it takes a long time, and there is a possibility that the operator makes a confirmation mistake. Further, in the evaluation of the application program by this operation confirmation, the evaluation for the same input event is repeated in order to improve the evaluation system. Then, in order to make the operation confirmation of the application program with high accuracy and efficiently, an automatic evaluation system is used in which a number of input events can be repeatedly and automatically inputted, and output results of the input events are automatically evaluated.

According to the foregoing automatic evaluation system, the application program operating on the target system can be automatically evaluated by using simulation results of a simulation unit. Thus, it is necessary to provide a memory which can be commonly accessed by the automatic evaluation system and the simulation unit, and by this, access between the automatic evaluation system and the simulation unit becomes possible. At this time, the simulation unit carries out normal processing to perform a simulation of the input event and to output the simulation result. Accordingly, it is not necessary to incorporate a procedure for automatic evaluation in the application program.

In the foregoing automatic evaluation system, it is necessary that an input event file be prepared in advance, and reference data corresponding to the input event file be prepared. Then, an input event is sequentially transmitted to the simulator, result data is received by referring to the display screen (display memory) on which the result of the simulation is reflected, and the result is compared with the reference data prepared in advance so that an automatic evaluation is carried out.

Now, in actual data, even if a key input is not actually made, the display screen is rewritten. That is, for example, there is a blinking cursor or a character moving around on the screen, and this is an input event other than a key input. For example, in the case of a blinking cursor, since it is rewritten into two kinds of screen contents of a non-reverse pattern and a reverse pattern by an application program operating on a target program, in the case where the automatic evaluation system reads this at a suitable timing, an accurate automatic evaluation cannot be carried out.

Accordingly, in order to obtain a highly reliable evaluation, it is necessary to read display screen data at a timing when the result of the simulation becomes definite and the rewriting of a screen is completed. Thus, conventionally, data of a portion corresponding to the blinking cursor was subjected to a mask processing or the like so that it did not become an object of evaluation. Alternatively, such a method was used so that a program operating on a target system was modified to stop the blinking.

Thus, in the former, the accuracy of the evaluation system is lowered, and in the latter, the quality of the program is degraded.

The present invention has been made in view of the above circumstances and has an object to provide an automatic evaluation method, an automatic evaluation system, and a storage medium storing an automatic evaluation program, in which evaluation accuracy is improved by setting, for each input event, the number of states of an output screen which the input event can take (kinds of the output screen on which the input event is reflected and which is renewed) as number-of-repetitions data, and repeating an evaluation for one input event that number of times.

### DISCLOSURE OF INVENTION

In order to solve the above problems, an automatic evaluation method as set forth in claim 1 is an automatic evaluation method for automatically evaluating a program operating on a target system by referring to an output screen as a result of a simulation corresponding to an arbitrary input event, in which the simulation is performed, reference to the output screen is made by a number of times corresponding to the number of states of the output screen on which the input event is reflected and which is renewed, and the reference result is successively compared with reference data corresponding to the number of times which is prepared in advance so that an automatic evaluation is carried out.

According to this automatic evaluation method, even if the state of the output screen is changed for one input event, mask processing is not performed, and it also becomes unnecessary to modify the program operating on the target system, so that the burden placed on a programmer is reduced.

Further, the evaluation is carried out one or more times for one input event, and eventually, evaluation accuracy can be improved.

Further, according to an automatic evaluation method as set forth in claim 2, in the method as set forth in claim 1, the number of times is set together with data of the input event.

According to this automatic evaluation method, for every input event, whether a state wherein the output screen renewed exists is set as number-of-repetitions data, and the evaluation can be repeated for one input event by the number of times, so that the evaluation accuracy can be improved.

In order to solve the above problem, an automatic evaluation system as set forth in claim 3 is an automatic evaluation system for automatically evaluating a program operating on a target system by referring to an output screen as a result of a simulation corresponding to an arbitrary input event, which comprises output screen reference means for, while the simulation is being performed, referring to the output screen by the number of times corresponding to the number of states of the output screen on which the input event is reflected and which is renewed, and evaluation means for successively comparing the reference result with reference data corresponding to the number of times which is prepared in advance so that the automatic evaluation is carried out.

According to this automatic evaluation system, the output screen reference means refers to the output screen by the number of times corresponding to the number of the output screen states which one input event can take, and the evaluation means repeats the evaluation by the number of times corresponding to the states. Thus, even if the state of the output screen is changed for one input event, mask processing is not performed, and it also becomes unnecessary to modify the program operating on the target system, so that the burden placed on the programmer is reduced. Further, the evaluation is carried out one or more times for one input event, so that evaluation accuracy can be improved and by this, an automatic evaluation system having a high performance can be obtained.

Further, according to an automatic evaluation system as set forth in claim 4, the system as set forth in claim 3 further comprises a simulation unit which performs the simulation and reports a display rewriting completion event every time the output screen is renewed by the number of times.

According to this automatic evaluation system, the output screen reference means repeats a reference to the output screen every time it receives notification of the display rewriting completion event from the simulation device, and transmits the reference data to the evaluation means. Thus, the evaluation means repeats the evaluation by the number of times corresponding to the states, and therefore, the evaluation accuracy can be improved.

In order to solve the problem, a storage medium storing an automatic evaluation program as set forth in claim 5 is a storage medium storing an automatic evaluation program for automatically evaluating a program operating on a target system by referring to an output screen as a result of a simulation corresponding to an arbitrary input event, and the automatic evaluation program comprises a step of reading an input event and reference data prepared in advance for the input event, a step of successively transmitting the read input event to cause execution of the simulation, a step of performing the simulation and referring to the output screen by the number of times corresponding to the number of states of the output screen on which the input event is reflected and which is renewed, and a step of carrying out an automatic evaluation by successively comparing the reference result with reference data corresponding to the number of times which is prepared in advance.

According to the storage medium storing the automatic evaluation program, the automatic evaluation can be carried out by using the simulation result of a simulator for the input event. Further, even if the state of the output screen is changed for one input event, mask processing is not performed, and it also becomes unnecessary to modify the program operating on the target system, so that the burden placed on the programmer is reduced. Besides this, the evaluation is carried out one or more times for one input event, so that evaluation accuracy can be improved.

Further, according to the recitation of claim 6, in the storage medium as set forth in claim 5, the automatic evaluation program further comprises a step of referring to the output screen every time a display rewriting completion event is received from a simulator, and repeating the automatic evaluation.

According to the storage medium storing the automatic evaluation program, the automatic evaluation system receives the display rewriting completion event, so that it can capture the result data of the simulation only at a timing when the simulation result becomes definite, in any state. Accordingly, stable reference data can be obtained, and an evaluation having a high reliability becomes possible by this.

### BRIEF DESCRIPTION OF DRAWINGS

FIG. 1 shows the structure of a personal computer in which an automatic evaluation system of an embodiment is operated.

FIG. 2 is a view for explaining the way of access between the automatic evaluation system of the embodiment and a simulator.

FIG. 3 is a view showing an example of an input event and a reference output result, in which (a) shows a key input, (b) shows a reference output screen of an LCD before the key input in view (a), and (c) shows the reference output screen of the LCD to the key input of view (a).

FIG. 4 is a function development view of a personal computer in an automatic evaluation system for realizing an automatic evaluation method according to an embodiment.

FIG. 5 is a flowchart of the automatic evaluation method according to the embodiment.

### BEST MODES FOR CARRYING OUT THE INVENTION

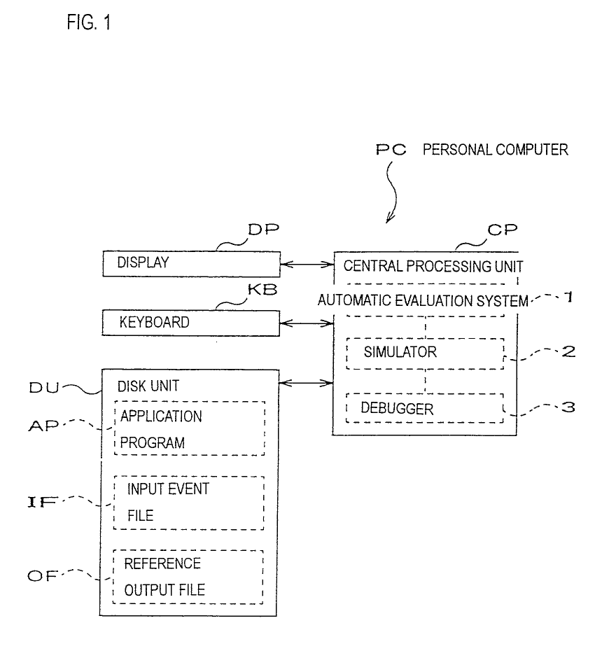

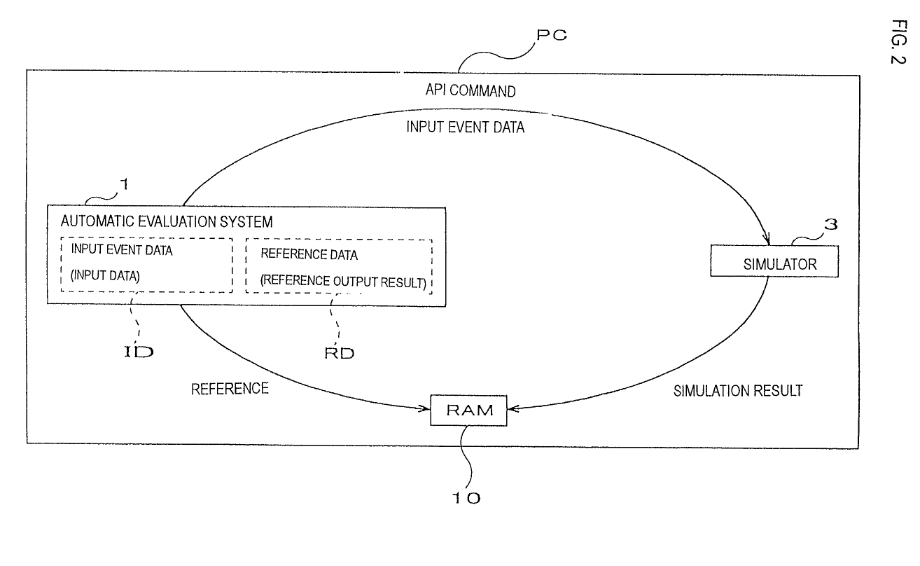

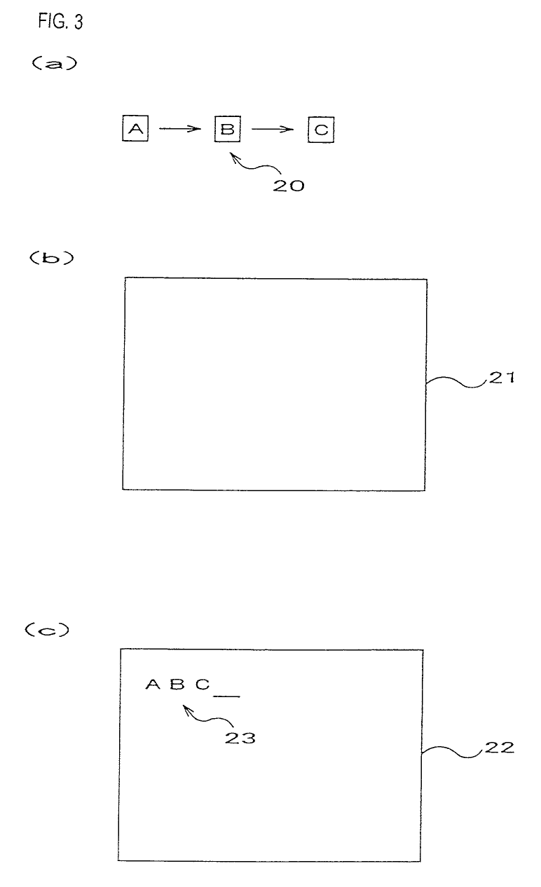

Hereinafter, embodiments of an automatic evaluation method of the present invention, an automatic evaluation system, and a storage medium storing an automatic evaluation program will be described with reference to the drawings. FIG. 1 is a structural view of a personal computer in which an automatic evaluation system and a simulator are operated, FIG. 2 is a view for explaining the form of access between the automatic evaluation system and the simulator, and FIG. 3 is a view showing an example of an input event and a reference output result, in which (a) shows a key input, (b) shows a reference output screen of an LCD before the key input of view (a), and (c) shows the reference output screen of the LCD to the key input of view (a).

According to the automatic evaluation system of the present invention and the automatic evaluation method, an application program operating on a target system can be automatically evaluated by using a simulation result from a simulator. At this time, the simulator carries out normal processing to perform a simulation corresponding to an input event and to output the result of the simulation. Thus, it is not necessary to incorporate a function for automatic evaluation into the application program. Further, in this automatic evaluation system and the automatic evaluation method, reference to an output screen is made by the number of times corresponding to the number of output screen states which one input event can take, and the automatic evaluation is repeated by the number of times corresponding to the states. Besides this, in the storage medium storing the automatic evaluation program according to the present invention, the automatic evaluation program is loaded into an electronic computer from this storage medium and is executed, so that the automatic evaluation system of the present invention can be formed, and the automatic evaluation by the automatic evaluation method of the present invention can be realized.

Incidentally, the target system is, for example, a microcomputer operating on the basis of the application program. The input event is set in correspondence to the specification of a device in which the target system is installed, and the target input event differs depending on the input means of the installation device. The target input event is, for example, a key input, a voice input or the like. The reference output result is a normal output of the target system to the input event, and is set in correspondence to the specification of the device in which the target system is installed, and the target reference output result differs depending on the output means of the installation device. The objective reference output result is a screen output, a voice output, or the like.

In this embodiment, the automatic evaluation system is formed as an automatic evaluation system in which an automatic evaluation program is loaded into a personal computer through a storage medium storing the automatic evaluation program, and the operations of the automatic evaluation program are executed in the personal computer to carry out an automatic evaluation. Further, in order to capture an input event and a reference output result, the automatic evaluation system uses a disk unit connected to the personal computer. Besides this, in this embodiment, the simulator is constructed as a simulation unit in which a simulation program is loaded into the personal computer from a storage medium storing the simulation program, and the operations of the simulation program are executed by the personal computer to perform a simulation. The automatic evaluation system and the simulator are formed in the same personal computer. Besides this, in this embodiment, the target system is a microcomputer. Further, in this embodiment, the microcomputer is installed in a device in which an external key (button) input is enabled and a screen output is made onto an LCD of a game, a watch, or a data bank.

First, the whole structure of an automatic evaluation system 1 and a simulator 3 will be described with reference to FIG. 1. In the automatic evaluation system 1, an automatic evaluation program is read from a storage medium storing the automatic evaluation program by a disk unit DU of a personal computer PC, and further, the automatic evaluation program is loaded into a main storage unit, and is executed by a central processing unit CP (including the main storage unit) to carry out an automatic evaluation. Incidentally, the disk unit DU is a unit which can read and write according to the type of storage medium such as a floppy disk or an optical disk. The automatic evaluation system 1 reads an input event stored in an input event file IF from the disk unit DU, and transmits this input event to the simulator 3. Further, the automatic evaluation system 1 reads a reference output result stored in a reference output file OF from the disk unit DU, and compares it with a simulation result of the simulator 3 to the input event to carry out an automatic evaluation.

The automatic evaluation system 1 stores an evaluation result as a result log file in the disk unit DU or makes a screen output onto a display DP.

In the simulator 3, a simulation program is read from a storage medium storing the simulation program by the disk unit DU of the personal computer PC, and further, the simulation program is loaded into the main storage unit and is executed in the central processing unit CP to perform a simulation. Besides this, the simulator 3 reads an application program AP of a microcomputer from the disk unit DU, and simulates an operation by this application program AP.

When the input event is transmitted from the automatic evaluation system 1, the simulator 3 simulates the operation by the application program AP on the basis of this input event. Then, the simulator 3 stores the simulation result in a RAM (Random Access Memory) 10 which is assigned to a part of the main storage unit of the personal computer PC as a shared memory accessed by the automatic evaluation system 1 of the present invention and the simulator 3 (see FIG. 2).

In the simulator 3, an external operation is enabled by a keyboard KB corresponding to the key input of the installation device, and the LCD screen is outputted onto the display DP corresponding to the screen output of the LCD of the installation device.

Incidentally, here, since the application program AP is debugged while the simulation is performed, the simulator 3 is connected to a debugger 2. In the debugger 2, a debug program is read from a storage medium storing the debugging program by the disk unit DU of the personal computer PC, is loaded into the main storage unit, and is executed by the central processing unit CP to perform debugging. The debugger 2 can start/stop the simulator 3, refer to data or rewrite data on the simulator 3, and the like. Further, the debugger 3 can execute the application program AP step-by-step, and can perform breaks.

Here, the input event file IF and the reference output file OF will be described. The input event file IF and the reference output file OF are prepared by using an input event data preparation function and a reference data preparation function of the automatic evaluation system 1, or are prepared by an editor in advance.

A description will be given of a case where the input event file IF is prepared by the automatic evaluation system 1. First, the respective keys of the installation device of the microcomputer are assigned to the respective keys of the keyboard KB. The user prepares a number of input events corresponding to the specification of the installation device, and inputs the keys one by one. In this way, the automatic evaluation system 1 determines the kind of key and the input sequence as input event data for each input event. Further, in the case where the output screen of the LCD of the installation device of the microcomputer is changed in response to one input event, the number of times corresponding to the number of states of the output screen to be renewed is used as input event data. Finally, the automatic evaluation system 1 stores the input event data for all input events in the input event file IF.

The input event file IF is given an arbitrary filename and is stored in the storage medium, and is set in a state where it can be read from the disk unit DU. The input event file IF can be changed in correspondence to changes in the specifications of the microcomputer, changes in the specifications of the installation device, changes in evaluation contents, and the like. For example, as shown in FIG. 3(a), it is assumed that a key operation is performed in the order of pressing the [A] key, the [B] key and the [C] key. In this case, in an input event 20, as input event data, the type of the A, B and C keys and the input order of the keys are stored as the input event data in the input event file IF. Further, in the case of a blinking cursor, since there are two states on the output screen for this input event, the number of times corresponding to the number of the states of the output screen is stored in the input event file IF.

Next, a description will be given of a case where the reference output file OF is prepared by the automatic evaluation system 1. Since reference data in which one or a plurality of reference output results are made to correspond to one input event is stored in the reference output file OF, it is prepared in correspondence to the preparation of the input event file IF. Here, in the case where there are a plurality of states of the output screen on which the input event is reflected and which is renewed for each input event, the reference output results are respectively set in accordance with the plurality of states of the output screen. For example, in the case of the blinking cursor, two reference output results are set.

Every time the user inputs an event including a key input, the automatic evaluation system 1 transmits, for example, the key input as the input event to the simulator 3. Then, the simulator 3 performs a simulation to this key input, and displays a simulation result on the display DP. After the display, the user confirms the display content of the display DP, and if correct, it becomes the definite reference output result. In the case where there are a plurality of simulation results for one input event, the plurality of simulation results are respectively determined as the reference output results. According to this embodiment, since the output means of the installation device is the LCD, the reference output result (reference data) is image data for the display of the LCD and position data on the display of the LCD.

In the case where the application program AP is in the middle of development, the reference output file OF is prepared to upgrading the application program AP. At this time, it is assumed that in the reference output file OF, a bug correction portion of the application program AP, a specification change portion and the like are added to the automatic evaluation items, and the automatic evaluation containing the changed portions of the application program AP can be carried out. Alternatively, after the user inputs the key of one input event, the image data for the display of the LCD may be prepared as the reference output result by a reference data preparation editor of the automatic evaluation system 1.

Finally, the automatic evaluation system 1 stores the reference data of all reference output results in the reference output file OF. The reference output file OF is given an arbitrary filename and is stored in the storage medium, and is set as a state where it can be read out form the disk unit DU. The filename of the reference output file OF is described in the input event file IF, and it is read out in accordance with the input event file IF. Accordingly, the reference output file OF is changed in accordance with the input event file IF. For example, as shown in FIG. 3(b), it is assumed that before the input event 20 is inputted, [_] is displayed at the upper left end on a reference output screen 21. Then, as the input event 20, when the key input of view (a) is performed, as shown in view (c), [ABC_] is displayed as a reference output result 23 from the upper left end to the right on a reference output screen 22 of the LCD. Incidentally, in the case where [_] is the blinking cursor, [ABC_] as a non-reverse pattern and [ABC ] as a reverse pattern are displayed as the reference output results 23. In this case, with respect to the reference output result 23, the image data for the display of the LCD of [ABC_] and [ABC ], and the display position data on the LCD screen are stored as the reference data in the reference output file OF.

Next, with reference to FIG. 2, the operation of the automatic evaluation system 1 and the simulator 3 when the automatic evaluation is carried out, will be described.

When the automatic evaluation system 1 is started by the user, the input event data ID stored in the input event file IF is loaded from the disk unit DU into the personal computer PC. Incidentally, the input event file IF is specified by means of a filename supplied by the user. When the input event file IF is loaded, the automatic evaluation system 1 loads the reference data RD stored in the reference output file OF of the filename described in the input event file IF into the personal computer PC.

Then, the automatic evaluation system 1 transmits one input event from the input event data ID to the simulator 3. API (Application Programming Interface) commands of the OS (Operating System) of the personal computer are used for the input event transmission. For example, in the case where the OS is Windows 98, the API command FindWindow is used to obtain a window handle of the simulator 3.

Then, the API command PostMessage is used, and one input event in the input event data ID is transmitted to the window handle. That is, the transmission of the input event is enabled between the automatic evaluation system 1 and the simulator 3 by the API commands. Since the automatic evaluation system 1 and the simulator 3 use functions provided in the OS, such as the API commands, it is not necessary to particularly add a function to transmit the input event.

Every time the input event is transmitted, the simulator 3 simulates the operation by the application program AP on the basis of this input event. Then, in order to carry out a display on the display DP, the simulator 3 temporarily stores the image data and the position data for the display of the LCD as the simulation result in a RAM 10. In the case where the number of times corresponding to the number of states of the output screen is set to a plural number in the input event data ID, simulation results corresponding to the number of times are temporarily stored. The simulator 3 also displays the image data for the display of the LCD stored in the RAM 10 on the display DP. The processing of the simulator 3 performed here is normally the same as the processing of the simulation of the operation by the application program AP, and a special processing is not performed for carrying out the automatic evaluation. Accordingly, as the application program AP, the same one as an application program actually installed in the microcomputer can be used. Incidentally, the RAM 10 is the main storage unit of the personal computer PC, and is formed by the RAM which can be shared by the automatic evaluation system 1 and the simulator 3. Accordingly, the RAM 10 can be accessed by the automatic evaluation system 1 and the simulator 3. That is, an exchange of simulation results is enabled through the RAM 10 between the automatic evaluation system 1 and the simulator 3. Since the automatic evaluation system 1 and the simulator 3 use the RAM 10 of the personal computer PC, it is not necessary to add a special function which refers to the simulation results. The RAM 10 may be a VRAM (Video RAM) included in the personal computer.

After the simulation, the automatic evaluation system 1 refers to the simulation result stored in the RAM 10. Then, the automatic evaluation system 1 compares the simulation result with the reference data (the image data and the position data for the display of the LCD) as the reference output result corresponding to the input event transmitted to the simulator 3 in the loaded reference data RD. The automatic evaluation system 1 determines whether both the results agree with each other, and evaluates the operation of the application program AP to the input event. Further, the automatic evaluation system 1 stores this determination result in the result log file. All the determination results may be stored in the result log file, or the determination results may be stored only in the case where the simulation results and the reference output results are different from each other.

Incidentally, the automatic evaluation system 1 may display the simulation result and the reference output result side by side on the display DP in a state that the user can check. Also, the automatic evaluation system 1 can display the determination result on the display DP.

Every time the evaluation of one input event is ended, the automatic evaluation system 1 repeats the foregoing processing for the next input event stored in the input event data ID and carries out the automatic evaluation. Then, the evaluation for all input events of the input event data ID ends, the automatic evaluation system 1 stores the result log file in the storage medium such as a hard disk in accordance with the instructions of the user, and ends the automatic evaluation.

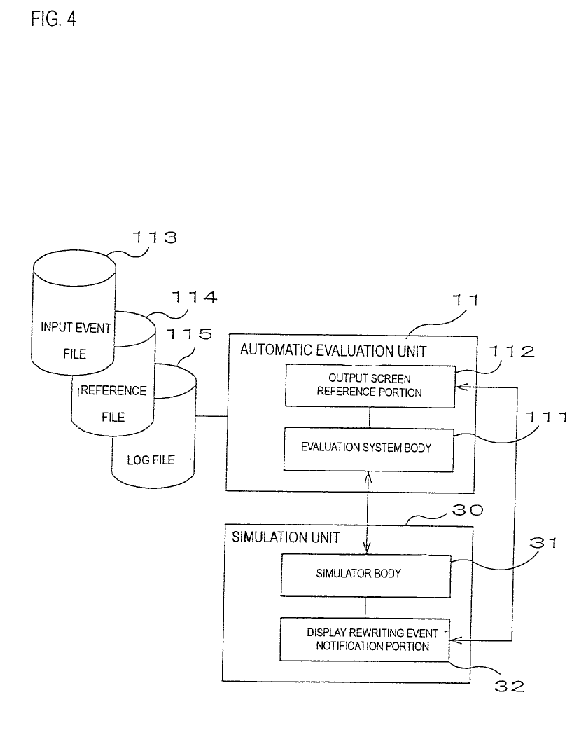

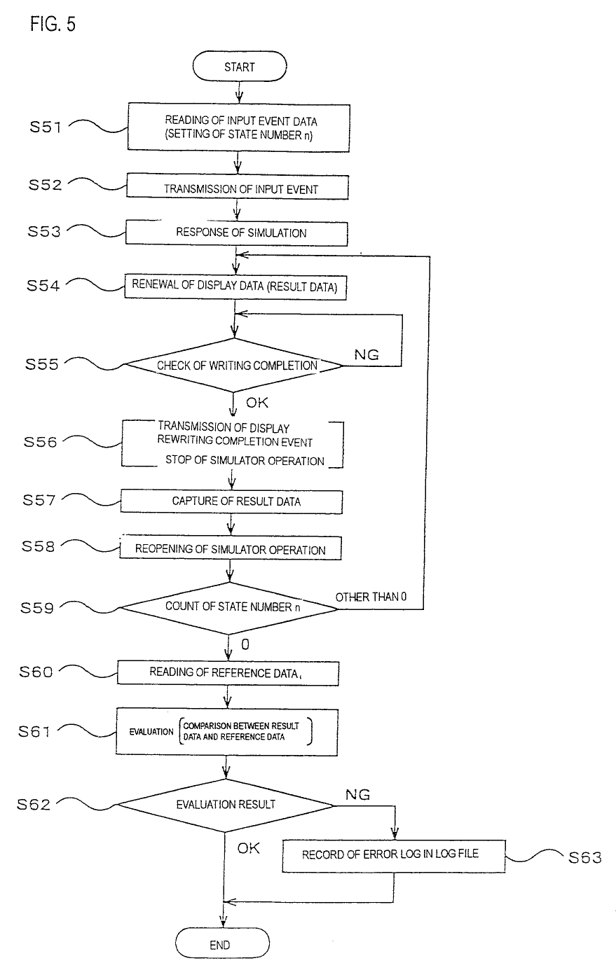

A detailed description will be given of the automatic evaluation in the case where there are a plurality of states of an output screen for one input event in the automatic evaluation system 1. FIG. 4 is a function development view of a personal computer as an automatic evaluation system for realizing an automatic evaluation method, and FIG. 5 is a flowchart showing the automatic evaluation method. In the drawing, blocks which are the same as those of FIG. 1 use the same numerals.

In FIG. 4, the automatic evaluation system of the present invention is roughly divided into an automatic evaluation unit 11 and a simulation unit 30. The simulation unit 30 includes a built-in simulator 31, and the simulator 31 simulates the operation of a program (application program AP) operating on a target system, and as described later, it monitors a timing when data renewal of an output screen on which the result is reflected becomes definite, and supplies it to the automatic evaluation unit 11 through a display rewriting event notification portion 32.

The automatic evaluation unit 11 is formed by an evaluation system core 111 and an output screen reference portion 112. As described later, every time the output screen reference portion 112 obtains timing information (display rewriting completion event) when data renewal of the output screen becomes definite from the simulation unit 30, it refers to the output screen at the timing, and supplies the reference data to the evaluation system core 111. The evaluation system core111 compares the reference result (simulation result) with reference data prepared in advance by the number of times corresponding to the number of states of the screen output on which the input event is reflected and which is renewed, so that the automatic evaluation is executed.

The simulation unit 30 is formed by the simulator 31 for performing a simulation and the display rewriting completion event notification portion 32 for checking for a display rewriting completion and for generating and outputting the display rewriting completion event. Incidentally, reference numeral 113 designates an input event file; 114, a reference file; and 115, a log file.

Hereinafter, the automatic evaluation method will be described in detail with reference to the flowchart shown in FIG. 5.

The automatic evaluation unit 11 reads the input event data ID from the prepared input event file 113 from the disk unit DU (step S51). Incidentally, as described above, the data of the number of times (n) corresponding to the number of states of the output screen to be renewed for one input event is also set in the input event data ID.

Next, the automatic evaluation unit 11 transmits the captured input event to the simulator 31 included in the simulation unit 30 by API commands (step S52). Then, the simulator 31 responds to the input event (step S53), and starts the simulation.

Next, the simulator 31 generates display data (result data) from the simulation and renews the content of the RAM 10 (step S54) Then, the simulation unit 30 checks whether or not writing of the simulation result data is completed (step S55) . Here, the simulation unit 30 continues checking until the writing is completed. Incidentally, the simulation unit 30 determines that rewriting of the simulation result data is completed when writing into the RAM 10 from the application program AP is not done for a certain amount of time or a cycle time. Further, after the completion of rewriting of the simulation result data (display data), the simulation unit 30 transmits the display rewriting completion event from the display rewriting event notification portion 32, and stops the simulation (step S56). Subsequently, after the reception of the display rewriting completion event, the automatic evaluation unit 11 captures the simulation result data (step S57). After the completion of capture, the automatic evaluation unit 11 transmits the screen data reading completion notification to the simulation unit 30. Then, after the reception of the screen data reading completion notification, the simulation unit 30 reopens the simulation (step S58).

Next, the automatic evaluation unit 11 counts the state number n (step S59). Then, in the case where the state number n is other than 0, the automatic evaluation unit 11 subtracts one from the state number n and continues to capture the simulation result data, and the simulator 31 executes the processing of step S54. On the other hand, in the case where the state number n is 0, the automatic evaluation unit 11 reads the reference data RD from the reference file 114 (step S60). Subsequently, the evaluation system core 111 of the automatic evaluation unit 11 compares the reference data RD with the simulation result data (step S61). The evaluation system core 111 determines whether or not the simulation result data agrees with the reference data RD, and evaluates the operation of the application program AP to the input event (step S62). In this evaluation, since n (the state number) pieces of simulation result data are captured, the evaluation system core 111 compares the n pieces of simulation result data with the reference data RD respectively in order to perform the determination. As a result, in the case where all the n pieces of simulation result data agree with the reference data RD, the automatic evaluation unit 11 ends the processing, and in the case where they do not agree with each other, the automatic evaluation unit stores an error log in the log file 115 and ends the processing (step S63).

The display rewriting event notification portion 32 included in the simulation unit 30 monitors a writing cycle of the result data at the same time as the generation of the result data, and thus, a time count is made for a predetermined time in advance to check the determination of the simulation result data and issues the display rewriting completion event (step S56). The output screen reference portion 112 of the automatic evaluation unit 11 waits for the arrival of the event from the display rewriting completion event notification portion 32, and captures the simulation result data at that time (step S57). Further, the automatic evaluation unit 11 counts the state number n (step S59), and in the case where the count value is other than 0, it continues to capture the simulation result data, and when the count value becomes 0, it reads the reference data RD corresponding to the simulation result data into the evaluation system core 111 (step S60). The evaluation system core 111 compares the simulation result data with the reference data RD and evaluates (step S61, S62). In this evaluation, the automatic evaluation unit 11 determines whether or not the n pieces of simulation result data agree with the reference data RD, evaluates the operation of the application program AP to the input event (step S62), and stores the result of the determination in the log file 115 (step S63).

As described above, according to this automatic evaluation system 1, the access between the automatic evaluation system 1 and the simulator 3 is enabled by accessing the API commands or the RAM 10. Thus, it is not necessary to add a specific function to the automatic evaluation system 1 and the simulator 3 in order to transmit the input event from the automatic evaluation system 1 to the simulator 3 and to refer to the simulation result data of the simulator 3 by the automatic evaluation system 1. Further, it is not necessary to install a function for automatic evaluation into the application program AP, and the same one as an application program actually installed in a microcomputer may be used. Further, according to this automatic evaluation system 1, even if there are a plurality of states of an output screen for one input event, an automatic evaluation to the respective output screen can be carried out.

The present invention is not limited to the foregoing actual mode, but can be carried out in various modes.

For example, although the API commands and the RAM are used for the communication between the automatic evaluation system 1 and the simulator 3, the invention is not limited to these means but may use other means.

Besides this, although the automatic evaluation system 1 and the simulator 3 are formed in the same personal computer, they may be formed in another electronic computer such as a workstation.

Besides this, a structure may also be adopted in which an automatic evaluation program stored in another computer is downloaded in a personal computer forming an automatic evaluation system and a simulator through a network and is executed.

According to an automatic evaluation method of the present invention, a simulation is performed, a reference to an output screen is made by the number of times corresponding to the number of states of an output screen on which an input event is reflected and which is renewed, and the reference result is successively compared with reference data prepared in advance and corresponding to the number of times so that an automatic evaluation is carried out, and therefore, even if the state of the output screen is changed for one input event, a mask processing is not performed, and it also becomes unnecessary to modify a program operating on a target system. Thus, the work load on a programmer is reduced, and further, since the evaluation is carried out one or more times for one input event, evaluation accuracy can be improved.

Further, according to the automatic evaluation method of the present invention, for each input event, the number of kinds of states for renewing the output screen that exist is set as number-of repetitions data, so that the evaluation can be repeated that number of times for one input event, and therefore, the evaluation accuracy can be improved.

According to the automatic evaluation system of the present invention, the output screen reference means refers to the output screen by the number of times corresponding to the number of the states which one input event can have, and the evaluation means repeats the evaluation by the number of times corresponding to the states. Thus, even if the state of the output screen is changed for one input event, a mask processing is not performed, and it also becomes unnecessary to modify the program operating on the target system, so that the burden placed on the programmer is reduced. Further, the evaluation is carried out one or more times for one input event, so that evaluation accuracy can be improved and by this, the automatic evaluation system having a high performance can be constructed.

According to the automatic evaluation system of the present invention, by the display rewriting completion event, the result data of the simulation can be captured only at the timing when the simulation result becomes definite, in any state. Accordingly, stable reference data can be obtained, and a highly reliable evaluation is enabled by this.

According to the storage medium storing the automatic evaluation program of the present invention, the automatic evaluation can be carried out by using the simulation result of the simulator to an input event, and even if the state of the output screen is changed for one input event, a mask processing is not performed, and it also becomes unnecessary to modify the program operating on the target system, so that the burden placed on the programmer is reduced. Besides this, the evaluation is carried out one or more times for one input event, so that the evaluation accuracy can be improved.

According to the storage medium storing the automatic evaluation program of the present invention, the display rewriting completion event is received, so that the result data of the simulation can be captured only at the timing when the simulation result becomes definite, in any state. Accordingly, stable reference data can be obtained, and highly reliable evaluation is enabled by this.

1. An automatic evaluation method for automatically evaluating a program operating on a target system by referring to an output screen as a result of a simulation corresponding to an arbitrary input event, the automatic evaluation method being characterized in that an automatic evaluation is carried out by:
performing the simulation and making reference to the output screen by a number of times corresponding to the number of states of the output screen on which the input event is reflected and which is renewed; and
successively comparing the reference result with reference data corresponding to the number of times which is prepared in advance so that an automatic evaluation is carried out.

2. An automatic evaluation method as set forth in claim 1, characterized in that the number of times is set together with data of the input event.

3. An automatic evaluation system for automatically evaluating a program operating on a target system by referring to an output screen as a result of a simulation corresponding to an arbitrary input event, the automatic evaluation system being characterized by comprising:
output screen reference means for, while the simulation is being performed, referring to the output screen by a number of times corresponding to the number of states of the output screen on which the input event is reflected and which is renewed; and
evaluation means for successively comparing the reference result with reference data corresponding to the number of times which is prepared in advance so that an automatic evaluation is carried out.

4. An automatic evaluation system as set forth in claim 3, characterized by further comprising a simulation unit which performs the simulation and reports a display rewriting completion event every time the output screen is renewed by the number of times.

5. A storage medium storing an automatic evaluation program for automatically evaluating a program operating on a target system by referring to an output screen as a result of a simulation corresponding to an arbitrary input event, the storage medium storing the automatic evaluation program being characterized in that
the automatic evaluation program comprises:
a step of reading an input event and reference data prepared in advance for the input event;
a step of successively transmitting the read input event to cause execution of the simulation;
a step of performing the simulation and referring to the output screen by the number of times corresponding to the number of states of the output screen on which the input event is reflected and which is renewed; and
a step of carrying out an automatic evaluation by successively comparing the reference result with reference data corresponding to the number of times which is prepared in advance.

6. A storage medium storing an automatic evaluation program as set forth in claim 5, wherein said program further comprises a step of referring to the output screen every time a display rewriting completion event is received from a simulator, and repeating the automatic evaluation.
